(19) United States
(12) Patent Application Publication
(10) Pub. No.: US 2016/0328935 A1
(43) Pub. Date: Nov. 10, 2016

(54) Open Scattered Light Smoke Detector Together With A Mobile Communication Device For Such An Open Scattered Light Smoke Detector For The Reception Of Detector Data And For Transmitting Update Data

(71) Applicant: Siemens Schweiz AG, Zuerich (CH)

(72) Inventor: Martin Fischer, Buelach (CH)

(73) Assignee: Siemens Schweiz AG, Zuerich (CH)

(21) Appl. No.: 15/147,975

(22) Filed: May 6, 2016

(30) Foreign Application Priority Data
May 6, 2015 (EP) 15166564.3

(51) Int. Cl. G08B 17/107

(52) U.S. Cl. CPC G08B 17/107

(57) ABSTRACT

An open scattered light smoke detector may include a light transmitter for emitting light, a light receiver spectrally matched to the light transmitter, and a control unit that actuates the light transmitter, using a pulsed signal sequence, to emit light pulses, evaluates a signal sequence received by the light receiver, and outputs a fire alarm if the received signal strength exceeds a minimum value for smoke concentration. The control unit may actuate the light transmitter with a binary data signal that encodes internal detector data, and/or may analyze a binary coded signal sequence received by the light receiver for a valid encoding of update data for the detector, and then load the validated update data. The detector data may include received signal strength data, optical path calibration data, configuration, operating or encryption data, a positional specification for a detector mounting site, a serial number, and/or a detector bus address.

### CROSS-REFERENCE TO RELATED APPLICATIONS

This application claims priority to EP Application No. 15166564.3 filed May 6, 2015, the contents of which are hereby incorporated by reference in their entirety.

### TECHNICAL FIELD

The invention relates to an open scattered light smoke detector which has a light transmitter for emitting light, in particular in the optically invisible range, and a light receiver which is spectrally matched to it. The detector incorporates a control unit which is connected to the light transmitter and the light receiver. This is equipped repeatedly, in particular periodically, to actuate the light transmitter, by means of a pulsed signal sequence, to emit corresponding light pulses, and to evaluate temporally a signal sequence received by the light receiver and to output a fire alarm if a signal strength of the received signal sequence exceeds a minimum value for the smoke concentration.

The invention further relates to a mobile communication terminal for data transmission with a scattered light smoke detector of this type which is located within communication range.

The pulsed signal sequence is preferably a rectangular timing signal which actuates the light transmitter at the same timing cycle, e.g. via a switch, so that a sequence of periodic light pulses is generated in the light transmitter. Following on from this, there again follows a dark period. Technical signal limitation of the light receiver at the same clock frequency effectively suppresses light signals at other frequencies. In practice, initially only the alternating portion of the light receiver's received signal is considered by the signal technology, and is then filtered by means of a bandpass filter matched to the clock frequency. The filtered signal is rectified and smoothed, and can subsequently be converted into a corresponding digital value by means of an A/D converter.

### BACKGROUND

Open scattered light smoke detectors are described, for example, in the international patent application WO 2001/031602 A1 and in the two European patent applications EP 2 093 733 A1 and EP 1 191 496 A1.

### SUMMARY

One embodiment provides an open scattered light smoke detector with a detection space, lying outside the detector, in which to detect smoke, with an associated light transmitter for emitting light and with a light receiver which is spectrally matched to it, wherein the detector has a control unit which is connected to the light transmitter and the light receiver, and wherein the control unit is equipped repeatedly to actuate the light transmitter, by means of a pulsed signal sequence, to emit corresponding light pulses, and to evaluate temporally a signal sequence received by the light receiver and to output a fire alarm if a signal strength of the received signal sequence exceeds a minimum value for the smoke concentration, wherein the control unit is equipped to actuate the light transmitter of the detector with a binary data signal, wherein the data signal encodes internal detector data, and/or is equipped to analyze a binary coded signal sequence, received by means of the light receiver, for a valid encoding of update data for the detector, and then to load it.

In one embodiment, the detector data includes the current signal strength, calibration data for the optical path of the detector, configuration data, operating data, encryption data, a positional specification for the detector mounting site, a serial number and/or a bus address of the detector.

In one embodiment, the update data includes calibration data for the optical path of the detector, configuration data, encryption data, a positional specification for the detector mounting site, a serial number and/or a bus address of the detector.

In one embodiment, the control unit is equipped to actuate the light transmitter with the binary coded data signal only if a binary coded signal sequence received beforehand by means of the light receiver agrees with a first code sequence stored in the detector.

In one embodiment, the control unit is equipped to load valid update data only if a binary coded signal sequence received beforehand by means of the light receiver agrees with a second code sequence stored in the detector.

In one embodiment, the control unit is equipped to receive by means of the light receiver, and to evaluate, the first and second code sequence in a measurement time window provided for that purpose, wherein the measurement time window concerned lies temporally between two pulsed signal sequences which are emitted.

In one embodiment, the control unit is equipped to indicate, optically and/or acoustically at the detector, an agreement with the first or second code sequence, and/or to acknowledge this agreement by the output by means of the light transmitter of a data signal encoded with a third code sequence.

In one embodiment, the control unit is equipped to output the data signal encoded with the detector data as a bit sequence, as a Manchester code sequence, a biphase-mark code, a return-to-zero code, a pulse-position code or a pulse-width code, and/or wherein the control unit is equipped to analyze a signal sequence received as an encoded bit sequence, a binary coded sequence for a Manchester code, a biphase-mark code, a return-to-zero code, a pulse-position code or a pulse-width code for a valid encoding and, in the event that a valid encoding is recognized, to decode the detector-side update data and then load it.

In one embodiment, the control unit is equipped to undertake the encoding of the data signal, and/or the decoding of a binary coded signal sequence which is received, on the basis of a data transmission protocol for infrared communication, in particular on an IrDA standard.

In one embodiment, the control unit is equipped to undertake the encoding of the data signal and/or the decoding of a binary coded signal sequence which is received on the basis of a data transmission protocol for infrared remote controls, in particular on an RC-5 or RC-6 data transmission protocol.

In one embodiment, the detector has a bandpass filter downstream from the light receiver, wherein the bandpass filter is constructed so that it can be switched over between a first filter frequency and a second filter frequency and wherein the switch-over is effected by the control unit, wherein the control unit is equipped to set the bandpass filter to the first filter frequency, for fire detection, and to actuate the light transmitter with a pulsed signal sequence which has a clock frequency corresponding to the first filter frequency, and wherein the control unit is equipped to set the bandpass filter to the second filter frequency, for the transmission of the detector and update data and to actuate, using a second clock frequency which corresponds to the second filter frequency, the light transmitter with a data signal which encodes the detector data.

In one embodiment, the light transmitter is an infrared LED and the light receiver is a photodiode which is spectrally matched to the infrared LED.

In one embodiment, the detector has a further infrared LED, which is provided for the monitoring of the detector for flow-masking objects which are present for long periods in the neighborhood of the detector and are detrimental to the detection of fire, and wherein the control unit is equipped to actuate, instead of the infrared LED, the further infrared LED, with the binary data signal which encodes the detector data.

Another embodiment provides a mobile communication device for data transmission of the detector data and/or of update data with a scattered light smoke detector as claimed in claim 12 or 13 which is located within communication range, wherein the mobile communication device has an infrared data interface for receiving detector data and/or for transmitting the update data and wherein the communication device has loaded on it an executable software application which is designed for decoding the detector data received and for displaying and storing the detector data on the communication device, and/or for encoding update data which is stored on or loaded onto the mobile communication terminal.

In one embodiment, the communication device is a smartphone, a tablet PC or a notebook.

### BRIEF DESCRIPTION OF THE DRAWINGS

Example aspects and embodiments of the invention are explained below with referent to the figures, in which:

FIG. 1 shows an example open scattered light smoke detector and an associated mobile communication terminal in accordance with one embodiment,

FIG. 2 shows an example of periodic pulsed signal sequences from a scattered light smoke detector with a binary coded data signal, inserted temporally between them, for the output of detector data in accordance with one embodiment,

FIG. 3 is a block circuit diagram of a scattered light smoke detector in accordance with one embodiment,

FIG. 4 shows an example of a data signal output following a request from a mobile communication terminal, in accordance with one embodiment, and

FIG. 5 shows an example of the loading of update data effected by the disclosed detector following a request from a mobile communication terminal.

### DETAILED DESCRIPTION

Embodiments of the invention provide an open scattered light smoke detector that may provide a simple wireless data transmission.

In some embodiments, the control unit is equipped for actuating the light transmitter of the detector with a binary data signal, wherein the data signal encodes internal detector data. Alternatively or additionally, the control unit is equipped to analyze a binary coded signal sequence, received by means of the light receiver, for a valid encoding of update data for the detector, and then to load it.

Some embodiments provide an advantageous use of an open scattered light arrangement which is already present, for the purpose of fire detection, for a uni- or bi-directional data transmission with a mobile communication terminal which is within communication range. This last is typically a smartphone with a suitable optical data interface already present in it. By this, it is possible in a simple way to read out alarm data from the scattered light smoke alarm and to transmit data for an update of the alarm.

Typically, the control unit will periodically actuate the light transmitter with a pulsed signal sequence to emit corresponding light pulses, such as for example every 2 seconds. Here, a pulsed signal sequence can have several hundred up to a few thousand pulses. The duration of such a signal sequence itself lies in the range from 0.25 up to 2 milliseconds. The duration of an individual pulse lies typically in the range from 0.5 up to 2 microseconds. The ratio of the signal sequence period to the time duration of a signal sequence itself thus lies in the range from two up to three orders of magnitude higher.

The term “encoding” or “decoding” means the conversion of a digital value, such as for example one bit or a series of bits, into a binary time sequence, and vice versa, suitable for serial data transmission. This conversion must not necessarily satisfy the requirement for data security.

The light transmitter is typically an infrared LED and the light receiver a photodiode which is spectrally matched to the infrared LED. The control unit will preferably be processor-supported, and in particular a micro-controller.

The detector can also have a further infrared LED, which is provided for monitoring the detector for flow-screening objects in the neighborhood of the detector, which are present for long periods and which are detrimental to the detection of fire. The control unit can be equipped now to actuate with the binary data signal the further infrared LED, which encodes the detector data, instead of the infrared LED.

In accordance with one embodiment, the detector data includes the current signal strength, calibration data for the detector's optical path, configuration data, operating data, encryption data, a positional specification for the detector mounting site, a serial number and/or bus address of the detector.

The current signal strength detected for a received signal sequence can, for example, be output encoded in the form of a percentage value and then displayed on the mobile communication terminal. A specialist can, for example, as part of a test of the detector, evaluate this signal strength value. Furthermore, calibration data for the detector's optical path can be output, such as for example detector-internal values for the amplification of the light receiver and for the driver stage of the light transmitter. It is also possible to output configuration data for the detector, such as for example the sampling frequency, the loudness of an acoustic alarm sounder or any type of operating mode which is set for the detector, such as for example robust operation in a rough environment of sensitive operation in an office.

Furthermore, the operating data can be, for example, fault data, event data or a current battery charge state. The detector data can further include a key or a key file for an encryption system, such as for example an AES key or a private PGP key. In addition, it is possible to output and display on the mobile communication terminal a positional specification for the detector mounting site, such as for example in the form of GPS data, or a manufacturing serial number and/or a bus address for the detector for communication with a danger monitoring center.

In accordance with a further embodiment, the update data includes calibration data for the detector's optical path, configuration data, encryption data, a positional specification for the mounting site of the detector, a serial number and/or a bus address for the detector.

By this means it is possible to transmit to a detector, e.g. as part of the manufacture, a bus address, a serial number or measured calibration data during the optical tuning of the detector. It is furthermore possible to transmit to the detector, as part of its commissioning “in the field”, a current positional specification for the mounting site of the detector, such as for example on the basis of a floor plan. Furthermore, it is possible later to load into the detector in operation in the field improved firmware as configuration data.

In accordance with one embodiment, the control unit is equipped to actuate the light transmitter with the encoded data signal only if a binary coded signal sequence received beforehand by means of the light receiver agrees with a first code sequence stored in the detector. This makes possible, as required, the reduced current consumption output of the detector data to the mobile communications terminal. Consequently, the first code sequence is an instruction to the inventive scattered light smoke detector to output the requested detector data.

In accordance with a further embodiment, the control unit is equipped to load valid update data only if a binary coded signal sequence received beforehand by means of the light receiver agrees with a second code sequence stored in the detector. Consequently, the second code sequence is an instruction to the inventive scattered light smoke detector to switch into receiving mode and to wait for the update data provided for transmission by the mobile communication terminal. By cyclic interrogation, the current consumption is reduced.

The control unit may be equipped to receive, by means of the light receiver, the first and/or second code sequence (only) in a measurement time window provided for that purpose, and to evaluate it. The two code sequences are different from each other. Here, the measurement time window concerned lies temporally between two pulsed signal sequences which are emitted. The two measurement time windows can be the one and same measurement time window. The two measurement time windows lie, in particular, not in the periodic measurement time window for smoke detection. Preferably, the transmission of the detector data or the receipt of the update data, as applicable, will be effected in each case between two signal sequences S. It can also be effected only in every second, third, fourth, etc. or up to in only every 50th period between two signal sequences S. By this means, the current consumption for the data transmission is further reduced.

The control unit may be equipped to indicate an agreement with the first or second code sequence optically and/or acoustically at the detector. The optical indication could be effected, for example, by a brief actuation of a red LED on the detector, which is typically actuated periodically to indicate the operational readiness of the detector. Alternatively or additionally, a buzzer or beeper on the detector could be briefly actuated. As a further alternative, or additionally, the agreement can be acknowledged by the output by means of the light transmitter of a data signal encoded with a third code sequence. On its receipt by the communication terminal, a successful loading of the detector data or successful transmission of the update data to the detector could even be acknowledged optically and/or acoustically on the communication device.

In one embodiment, the control unit is equipped to output the data signal encoded with the detector data as a bit sequence, as a Manchester code sequence, a biphase-mark code, a return-to-zero code, a pulse-position code or a pulse-width code. Alternatively or additionally, the control unit can be equipped to analyze for a valid encoding a signal sequence received as an encoded bit sequence, a binary coded sequence for a Manchester code, a biphase-mark code, a return-to-zero code, a pulse-position code or a pulse-width code, and in the event that a valid encoding is recognized to decode and then load the detector-side update data. With the exception of the encoded bit sequence, the encoding rules cited above are especially well suited as “line codes” for wireless transmission.

The detector data to be transmitted and the update data to be received may be encrypted, wherein the detector and the mobile communication terminal have the relevant keys for the required encryption and decryption. The encryption can be a symmetric or an asymmetric encryption, such as for example an AES or PGP encryption. The encryption of the detector data together with the decryption of the update data is effected by the detector's control unit by suitable algorithms, realized as software, on the basis of the key(s) stored in the detector.

In one embodiment, the control unit is equipped to undertake the encoding of the binary data signal, and/or the decoding of a binary coded signal sequence which is received, on the basis of a data transmission protocol for infrared communication, in particular on an IrDA standard.

As an alternative, the control unit can be equipped to undertake the encoding of the binary data signal, and/or the decoding of a binary coded signal sequence which is received, on the basis of a data transmission protocol for infrared remote controls, in particular on an RC-5 or RC-6 data transmission protocol.

In one embodiment, the detector has a bandpass filter downstream from the light receiver. The bandpass filter is constructed so that it can be switched over between a first filter frequency and a second filter frequency. The switch-over is effected under the control of the control unit. The downstream bandpass filter allows predominantly only those signal portions to pass which agree with the first or the second filter frequency. By the signal-technological limitation of the light receiver to one of the two filter frequencies, light signals at other frequencies are effectively suppressed. The control unit is equipped to set the bandpass filter to the first filter frequency, for fire detection, and to actuate the light transmitter with a pulsed signal sequence which has a clock frequency corresponding to the first filter frequency. The control unit is further equipped to set the bandpass filter to the second filter frequency, for the transmission of the detector and update data, and to actuate the light transmitter with a data signal which encodes the detector data using a second clock frequency which corresponds to the second filter frequency.

The second filter frequency may be lower than the first filter frequency. Typically, the first filter frequency, and hence also the first clock frequency, lies in the range from 500 kHz to 2 MHz. It has, for example, a filter bandwidth of less than 50 KHz.

By the comparatively high first filter and clock frequency, any interference by pulsed light from infrared remote controls in the surrounding area is effectively suppressed. Their transmission frequency lies significantly below the first frequencies cited above. Thus the typical clock frequency, i.e. the carrier frequency of infrared remote controls, lies in a range from just 30 up to 50 KHz. The typical carrier frequencies of pulsed infrared light from IrDA sources lie in the range from 18 KHz up to several hundred MHz.

The setting of two filter and clock frequencies which differ from one another makes possible, on the one hand, reliable and very interference-resistant fire detection, and on the other hand reliable optical data transmission on the basis of known standardized transmission procedures.

Other embodiments provide a mobile communication device for the data transmission of detector data and/or of update data with a scattered light smoke detector located within the communication range. The mobile communication terminal has an infrared data interface for receiving detector data and/or for transmitting the update data. For this purpose, the communication device has loaded on it a software application, which is designed for decoding the detector data received, and for displaying and storing the detector data on the communication device. The software application can, alternatively or additionally, be equipped for encoding update data which is stored on or loaded onto the mobile communication terminal.

By this means it is possible, as part of the manufacture, the commissioning or the servicing, in a very simple way to read detector data out from the inventive detector or to load update data onto the inventive detector. In such a case, the communication terminal is optically aligned towards the detector provided.

The executable software application which is loaded onto the communication device can, in addition, be designed for the encryption of the update data which is to be transmitted and/or for the decryption of detector data which is loaded. For this purpose, the associated keys for the encryption concerned are stored as files on the mobile communication terminal.

In one embodiment, the mobile communication terminal is a smartphone, a tablet PC or a notebook. Devices of this type typically already have a suitable infrared interface, in particular an IrDA interface.

FIG. 1 shows by way of example, an open scattered light smoke detector 1 and an associated mobile communication terminal 10 in accordance with one embodiment. The scattered light smoke detector 1 shown is affixed to a ceiling. The reference mark 2 indicates a detector housing. The detector 1 has in addition an electronic control unit 3 which, among other matters, is provided for the electrical actuation of an infrared LED 4 as the light transmitter with a pulsed signal sequence and for capturing, and performing a temporal evaluation on, a signal sequence received by an IR photodiode 5 as the light receiver. DR is the reference mark for a detection space, lying outside the detector housing 2, in which smoke is to be detected. In the case when a fire alarm AL is detected, this is forwarded via a connected detector line ML to a fire alarm center BMZ. The reference mark 6 identifies a further infrared LED, which is provided for the monitoring of the detector for flow-masking objects which are present for long periods in the neighborhood of the detector and are detrimental to the detection of fire, in particular within a radius of a half meter.

In one embodiment, the control unit 3 is now equipped to actuate the light transmitter 4 of the detector 1 with a binary data signal D, wherein the data signal D encodes internal detector data DAT. In the present example, the control unit 3 is equipped in addition to analyze a binary coded signal sequence R, which is received by means of the light receiver 5, for a valid encoding of update data UPDAT for the detector 1, and then to load it.

The data transmission, which is here bidirectional, is made possible by a mobile communication terminal 10 which is located within the communication range. In the present example this is a smartphone, which is known per se. Such a device 10 incorporates an infrared data interface 11, typically an IrDA data interface. The infrared data interface 11 is here spectrally matched to the light transmitter(s) 4, 6 and to the light receiver 5. Furthermore, loaded on the mobile communication device 10 is a software application APP which is executed by a microprocessor, not shown further, of the communication device 10. This software application APP is suitable, or is suitably programmed, to receive, via the infrared data interface 11, detector data DAT or a binary infrared signal encoded with the detector data DAT, to decode it, to store it and if applicable to decrypt it, and to display it on a display unit 12 of the communication terminal 10. The software application APP can alternatively or additionally be suitably programmed, if appropriate, to encrypt update data UPDAT stored in the mobile communication terminal 10, which is intended for updating the inventive scattered light smoke detector 1, then to encode it and finally to emit it via the infrared data interface 11 as an encoded binary infrared signal.

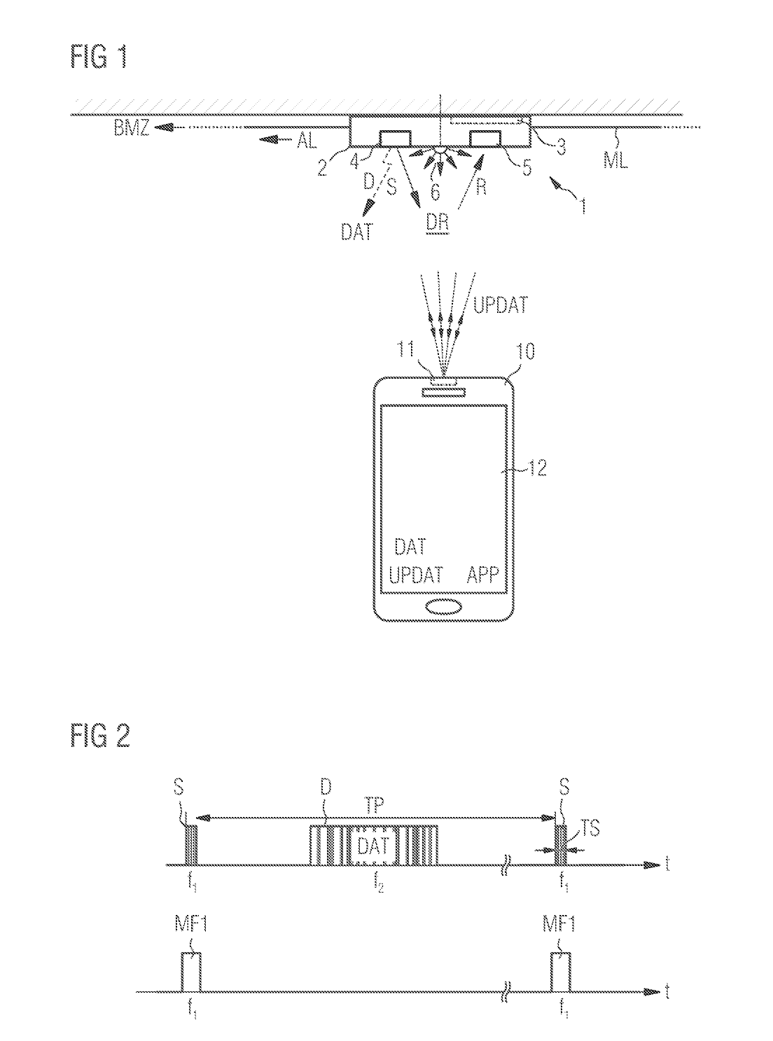

FIG. 2 shows an example of periodic pulsed signal sequences S from a scattered light smoke detector 1 with a binary coded data signal D, inserted temporally between them, for the output of detector data DAT.

TP indicates the period of the pulsed signal sequence S. This typically lies in a range from 1 to 10 seconds. TS indicates the duration of the transmission time for an individual signal sequence S. This typically lies in a range from 0.5 to 2 milliseconds. Between two pulsed signal sequences S which are emitted, a pulsed data signal D is output, which encodes the detector data DAT. The duration of such a data signal D depends on the quantity of data, i.e. on the number of data items transmitted together with their digital resolution. The transmission of the data will preferably be effected in modulated form with a carrier frequency of, for example, 36 or 40 kHz, or even of several MHz. If, for example, a time span of 1 millisecond or 0.1 milliseconds is used for the carrier-frequency modulated transmission of a single bit, then there is, for example, no problem in transmitting 1000 bits or 10000 bits between two signal sequences S with a period TP of 2 seconds. The transmission of the detector data DAT can in each case be effected between two signal sequences S. It can also be effected only in every second, third, fourth period, etc. up to only in every 50th period between two signal sequences S.

The timing diagram below shows two measurement time windows MF1. Only within these measurement time windows MF1 does the light receiver effect optical capture for possible scattered light signals. As shown further in FIG. 2, smoke detection is effected using a first filter and clock frequency f1, while the emission of the data signal D is effected using an underlying second clock frequency f2, which typically corresponds to the carrier frequency. As described in the introduction, the transmission of the detector data DAT can be based on a data transmission protocol for infrared communications, in particular on an IrDA standard, or on a data transmission protocol for infrared remote controls.

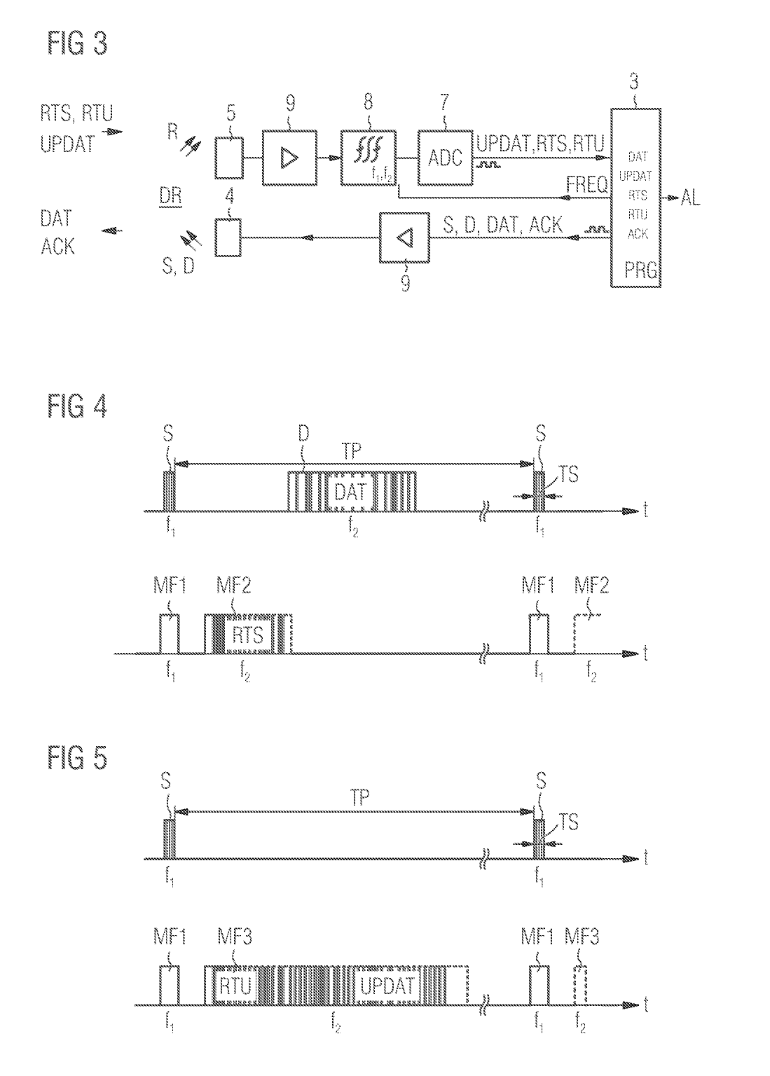

FIG. 3 shows a block circuit diagram of a scattered light smoke detector 1 in accordance with one embodiment. Shown in the left-hand part of the figure are the light transmitter 4 and the light receiver 5.

In circuit before the light transmitter 4 is a signal processor, such as for example an amplifier 9, which outputs a periodic signal sequence S, which is output by the control unit 3, together with the binary data signal D. Here, the data signal D is a serial signal which encodes the detector data DAT. For this purpose, the control unit 3 has a program PRG, realized in software, which converts the detector data DAT which is to be output into a suitable signal sequence, such as for example a Manchester code sequence. The control unit 3 can also output a third code sequence ACK on this signal path, to confirm the valid receipt of update data UPDAT.

The light receiver 5 which is shown is followed by a signal amplifier 9 for amplifying the light signal or infrared signal, as applicable, which had been received. The downstream bandpass filter 8 allows mainly only those signal portions to pass which are set by a first or second filter frequency f1, f2. The setting is effected via a frequency switch-over signal FREQ output by the control unit 3. For the smoke detection mode of operation, the clock frequency of the emitted signal sequence S agrees with the first filter frequency f1 set on the bandpass filter 8. A downstream A/D converter 7 converts the filtered signal into a sequence of digital values which, as the received signal sequence R, are correlated by signaling technology with the transmitted signal sequence S. The A/D converter 7 can also be an integral part of the control unit 3 itself.

For the data transmission mode of operation, i.e. for the transmission of detector data DAT and update data UPDAT, the control unit 3 outputs a changed frequency switch-over signal FREQ, so that only those portions of the signal which agree with the second filter frequency pass the bandpass filter 8. The filtered signal is again converted by means of the downstream A/D converter 7 into a sequence of digital values, and is analyzed by the control unit 3 in respect of coding contained in it for update data UPDATE and for any first and second code sequence RTS, RTU it contains. The two code sequences RTS, RTU are emitted by a mobile communication terminal, in order to indicate to the inventive scattered light smoke detector 1 that detector data DAT are to be read out from the detector 1 or that update data UPDAT is available to load into the detector 1. FIG. 4 and FIG. 5 which follow are to illustrate this.

FIG. 4 shows an example of a data signal D in accordance with one embodiment, as output following a request from a mobile communication terminal. The present timing diagram differs from that in FIG. 2 in that a second measurement time window MF2 is provided on the detector side, in which is awaited the arrival of at least one first binary coded code sequence RTS. If such a code sequence RTS is detected then, preferably immediately thereafter, the detector outputs the data signal D by which is encoded the detector data DAT. Both the detection of the first code sequence RTS and also the subsequent emission of the data signal D are effected using the second filter and clock frequency f2. The second measurement time window MF2 can also follow in time immediately after the first measurement time window MF1. When the second measurement time window MF2 starts, a frequency switch-over is effected for the filter frequency f1, f2 of the high-pass filter 8, from the first to the second filter frequency f1, f2.

FIG. 5 shows an example of the loading of update data UPDAT effected by the inventive detector following a request from a mobile communication terminal. The present timing diagram differs from that in FIG. 4 in that a third measurement time window MF2 is provided on the detector side, in which is awaited the arrival of a second binary coded code sequence RTU. If such a code sequence RTU is detected then, preferably immediately thereafter, the receipt takes place of the prenotified update data, which is encoded in the received signal sequence R.

The two measurement time windows MF2, MF3 must not necessarily be available in each period TP. The can also be available only in each second, third, fourth period TP etc. Preferably, the two measurement time windows MF2, MF3 will be identical. In other words, the arrival of the first or the second code sequence RTS, RTU is then awaited. The two measurement time windows MF2, MF3 will preferably have a duration in the range from 1 to 50 milliseconds.

### LIST OF REFERENCE MARKS

1 Open scattered light smoke detector
2 Detector housing
3 Electronic control unit, processor, micro-controller
4 Light transmitter, LED, IRED
5 Light receiver, photodiode, IR photodiode
6 Further light transmitter, environment light transmitter, IRED
7 Amplifier
8 Bandpass filter
9 Comparator, signal processor
10 Communication device, smartphone
11 Infrared data interface
12 Display and operating unit, touchscreen
ACK Acknowledgement, acknowledgement signal
AL Alarm message, warning message
APP, PRG Program, application
BMZ Danger reporting center, fire reporting center
D Data signal
DAT Detector data
DR Detection space, scattered light region
f1, f2 Filter frequency, clock frequency
FREQ Frequency switch-over signal
MF, MF2, Measurement time windows
MF3
ML Detector line, detector bus, two-wire line
R Received signal sequence
RTS Transmit request, transmit request signal
RTU Update request, update request signal
S Pulsed signal sequence
t Time, time axis
TP Duration of period, period
TS Duration of transmission
UPDAT Update data

What is claimed is:

1. An open scattered light smoke detector, comprising:
a light transmitter configured to emit light,
a light receiver spectrally matched to the light transmitter,
a control unit connected to the light transmitter and the light receiver, wherein the control unit is configured to:
actuate the light transmitter using a pulsed signal sequence,
emit corresponding light pulses,
determine a signal strength of a signal sequence received by the light receiver and
output a fire alarm in response to determining that the signal strength of the received signal sequence exceeds a minimum value for smoke concentration,
wherein the control unit is configured to at least one of:
actuate the light transmitter using a binary data signal that encodes internal detector data, or
analyze a binary coded signal sequence received by the light receiver for a valid encoding of update data for the detector, and upon validating the update data, to load the validated update data.

2. The detector of claim 1, wherein the detector data includes at least one of a current signal strength, calibration data for an optical path of the detector, configuration data, operating data, encryption data, a positional specification for a detector mounting site, a serial number, or a bus address of the detector.

3. The detector of claim 1, wherein the update data includes at least one of calibration data for an optical path of the detector, configuration data, encryption data, a positional specification for a detector mounting site, a serial number, or a bus address of the detector.

4. The detector of claim 1, wherein the control unit is configured to actuate the light transmitter using the binary coded data signal only if a binary coded signal sequence previously received by the light receiver matches a first code sequence stored in the detector.

5. The detector of claim 1, wherein the control unit is configured to load valid update data only if a binary coded signal sequence previously received by the light receiver matches a second code sequence stored in the detector.

6. The detector of claim 4, wherein the control unit is configured to receive and evaluate the first and second code sequence during a measurement time window that lies temporally between two pulsed signal sequences emitted by the light transmitter.

7. The detector of claim 4, wherein the control unit is configured to generate an optical or acoustic notification of an agreement with the first or second code sequence, and to control the light transmitter to output a data signal encoded with a third code sequence indicating such agreement.

8. The detector of claim 1, wherein the control unit is configured to at least one of:
output the data signal encoded with the detector data as a bit sequence, as a Manchester code sequence, a biphase-mark code, a return-to-zero code, a pulse-position code, or a pulse-width code, or
analyze a signal sequence received as an encoded bit sequence, a binary coded sequence for a Manchester code, a biphase-mark code, a return-to-zero code, a pulse-position code, or a pulse-width code for a valid encoding and, in response to determining a valid encoding, to decode the detector-side update data and then load the update data.

9. The detector of claim 8, wherein the control unit is configured to perform the encoding of the data signal or the decoding of a received binary coded signal sequence based on an IrDA standard data transmission protocol for infrared communication.

10. The detector of claim 8, wherein the control unit is configured to perform the encoding of the data signal or the decoding of a received binary coded signal sequence based on an RC-5 or RC-6 data transmission protocol for infrared remote controls.

11. The detector of claim 1, wherein:
the detector includes a bandpass filter downstream from the light receiver, wherein the bandpass filter is switchable by the control unit between a first filter frequency and a second filter frequency,
wherein the control unit is configured to set the bandpass filter to the first filter frequency for fire detection, and to actuate the light transmitter with a pulsed signal sequence having a clock frequency corresponding to the first filter frequency, and
wherein the control unit is configured to set the bandpass filter to the second filter frequency for data transmission and to actuate, using a second clock frequency that corresponds to the second filter frequency, the light transmitter with a data signal that encodes the detector data.

12. The detector of claim 1, wherein the light transmitter is an infrared LED and the light receiver is a photodiode that is spectrally matched to the infrared LED.

13. The detector of claim 12, further comprising:
a further infrared LED configured to monitor the detector for flow-masking objects that are present for long periods near the detector and are detrimental to fire detection, and
wherein the control unit is configured to actuate the further infrared LED, instead of the infrared LED, using the binary data signal that encodes the detector data.

14. A mobile communication device configured to communicate with a scattered light smoke detector having an infrared LED light transmitter configured to emit light, a photodiode light receiver spectrally matched to the light transmitter, and a control unit configured to actuate the infrared LED light transmitter, determine a signal strength of a signal sequence received by the photodiode light receiver, and output a fire alarm based on the determined signal strength, wherein the control unit is configured to at least one of (a) actuate the light transmitter using a binary data signal that encodes internal detector data, or analyze a binary coded signal sequence received by the light receiver for a valid encoding of update data for the detector, and upon validating the update data, to load the validated update data, the mobile communication device comprising:
an infrared data interface configured to at least one of receive the detector data or transmit the update data, and
non-transitory computer-readable media storing a software application executable by a processor to at least one of (a) decode the received detector data and display and store the decoded detector data on the mobile communication device, or (b) encode update data that is stored on or loaded onto the mobile communication device.

15. The mobile communication device of claim 14, wherein the mobile communication device is a smartphone, a tablet computer, or a notebook computer.
